(19) United States
(12) Patent Application Publication
(10) Pub. No.: US 2002/0093140 A1
(43) Pub. Date: Jul. 18, 2002

(54) Flexible seal for rotating drum

(76) Inventor: Nigel P. Wright, Marion, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 09/761,936

(22) Filed: Jan. 17, 2001

(51) Int. Cl. F16J 15/32

(52) U.S. Cl. 277/309

(57) ABSTRACT

A flexible seal is provided for sealing engagement between a rotating drum and a stationary air duct. The seal includes an elongated mounting member adapted to frictionally fit over the edges of the duct, and a resilient bulb extending from the mounting member. An HMWP wear strip is mounted on the bulb so as to be in sealing engagement with the curved surface of the drum.

### BACKGROUND OF THE INVENTION

Rotating drums, such as those used in particulate coating machines, typically are perforated so that air can flow through the drum to facilitate drying of a coating solution on the particulate material. Air is supplied through an inlet duct and is exhausted through an outlet duct. In prior art coating machines, a leaf-type seal is mounted on the stationary exhaust duct to effect a seal between the rotating surface of the drum and the periphery of the duct. The efficiency of the seal has a direct effect on the efficiency of the coating process.

Prior art seals typically have been constructed from multiple parts requiring numerous screws to complete the seal assembly. Prior art seals are also subject to damage when the duct is positioned against the drum. For example, the thin, plastic seal material has been known to become folded inside the duct, thereby causing an air leak which reduces the efficiency of the coating process. Also, the conventional thin, plastic seal is prone to wear and early failure. Failure of the seal also exposes the rotating drum surface to potential damage from the metallic spring support fingers of the seal.

Accordingly, a primary objective of the present invention is to provide an improved seal between a rotating drum and a stationary duct.

A further objective of the present invention is the provision of an improved particulate coating machine having an efficient and durable flexible seal between the rotating drum and the air duct.

Another objective of the present invention is the provision of a seal for the perimeter edge of a duct adjacent a rotating drum which can be quickly and easily installed without the use of tools.

These and other objectives will become apparent from the following description of the invention.

### SUMMARY OF THE INVENTION

The seal of the present invention is adapted to provide an efficient seal between a rotating drum and a stationary duct, such as in a particulate coating machine. The duct has a perimeter edge with opposite curved sides and opposite ends spaced closely to the curved surface of the drum. The seal includes an elongated extruded member adapted to fit over at least the curved edge of the duct. The extruded mounting member includes spaced apart legs which can be friction fit onto the curved edge of the duct without the use of tools. A resilient bulb extends from the mounting member and has a relatively thick wear strip mounted thereon so as to be in sealing engagement with the drum. Preferably, the bulb is constructed of neoprene sponge rubber, and the wear strip is constructed of HMWP material. The flexibility of the bulb assures that the wear strip will remain in contact with the rotating drum.

### BRIEF DESCRIPTION OF THE DRAWINGS

FIG. 1 is a perspective view of a particulate coating machine with a rotating drum.

FIG. 2 is a partial sectional view of the drum and associated exhaust duct taken along lines 2-2 of FIG. 1.

FIG. 3 is an enlarged view taken along lines 3-3 of FIG. 2.

FIG. 4 is a partial elevation view taken along lines 4-4 of FIG. 2.

FIG. 5 is a view similar to FIG. 3 showing a prior art leaf seal.

FIG. 6 is a view similar to FIG. 4 showing the prior art leaf seal.

### DETAILED DESCRIPTION OF THE DRAWINGS

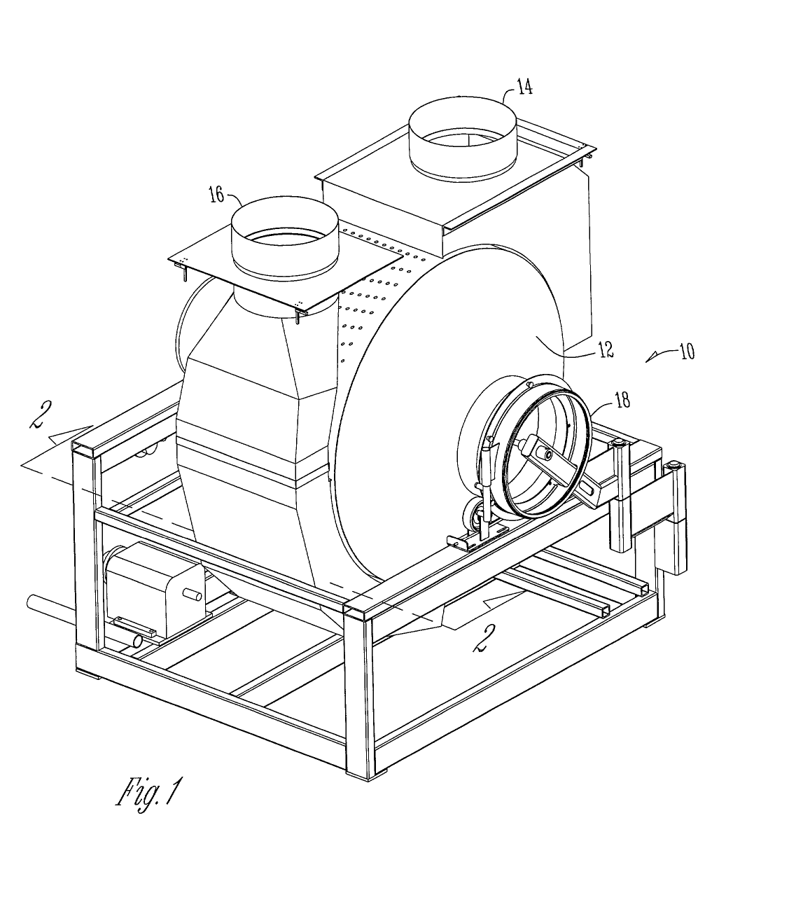

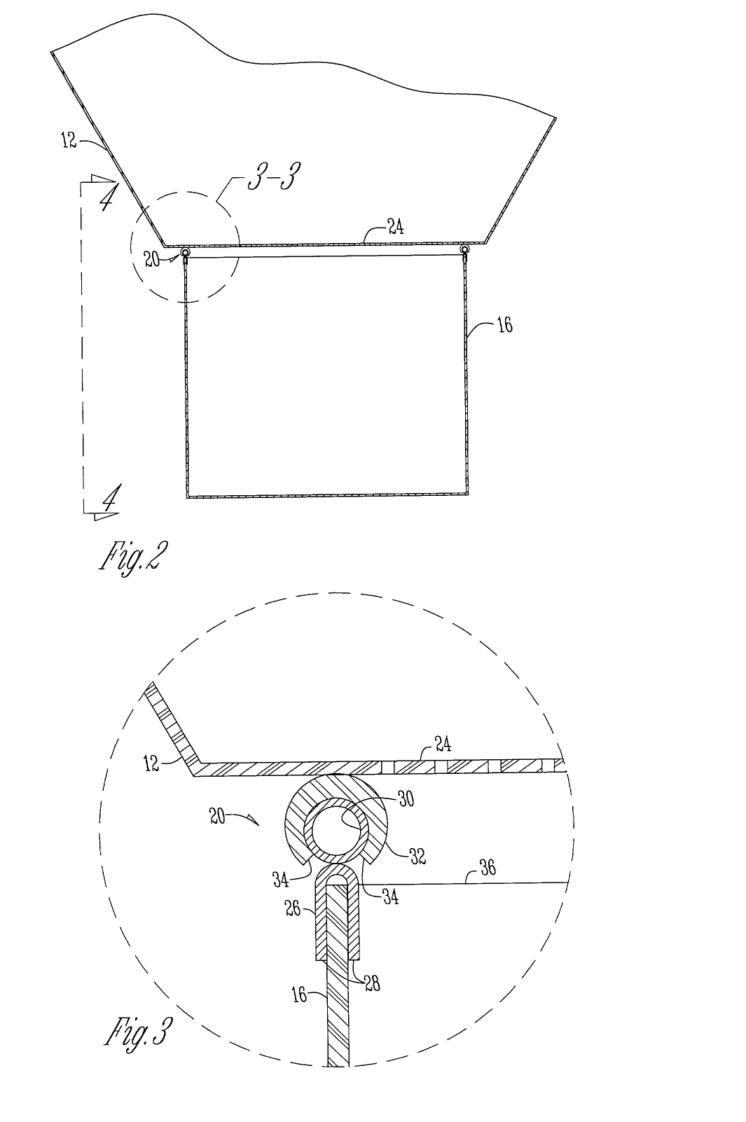

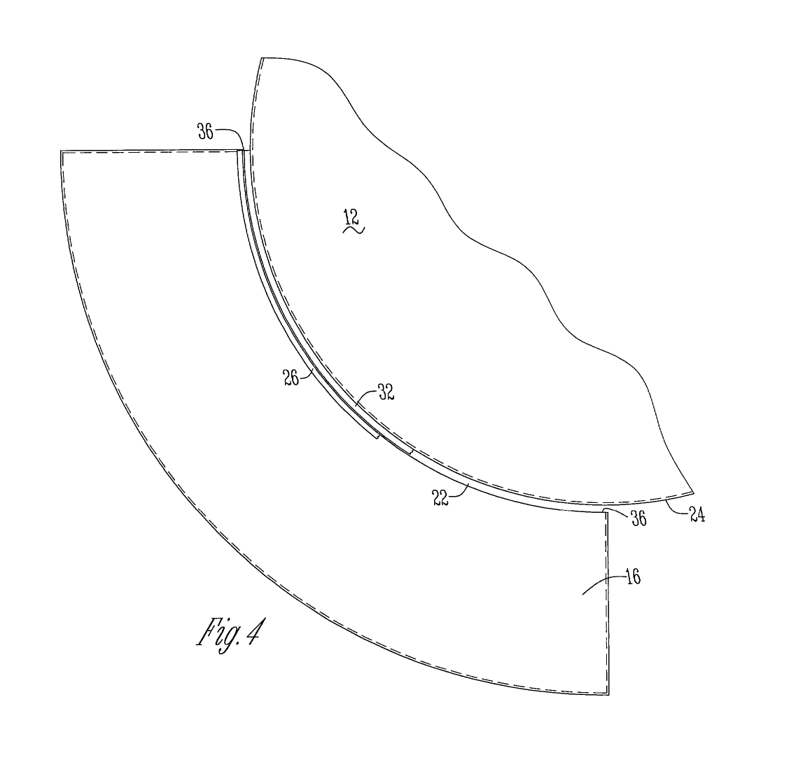

A particulate coating machine is generally designated in FIG. 1 by the reference numeral 10. The machine includes a rotatable perforated drum 12, an air inlet duct 14, and an air outlet duct 16. The drum includes a front opening for loading and unloading particulate material to and from the drum 12. A door 18 is movable between open and closed positions relative to the drum opening. The structure of the drum 12, ducts 14, 16 and door 18 is conventional, and does not constitute a part of the present invention.

The present invention is directed towards a flexible seal 20. The seal 20 is adapted to be mounted on at least the curved opposite edges 22 of at least the outlet duct 16, and preferably also on the inlet duct 14. The seal 20 engages the curved perimeter surface 24 of the drum 12.

More particularly, the flexible seal 20 includes an elongated mounting member 26 having a pair of spaced apart legs 28. Preferably, the mounting member 26 is constructed of an extruded vinyl material. The legs 28 are adapted to reside on either side of the curved edge 22 of the ducts 14, 16, as best seen in FIG. 3. The legs 28 are adapted to be manually press fit onto the edges 22 of the ducts 14, 16 and retained thereon by friction.

The flexible seal 20 also includes a bulb 30 extending from the mounting member 26. Preferably, the bulb is made from a neoprene sponge rubber material so as to be resilient. A wear strip 32 is mounted on the bulb 30. Preferably, the wear strip 32 is made from high molecular weight polyethylene (HMWP). As seen in FIG. 3, the wear strip 32 is curved in cross section, and extends approximately 270° so as to define an opening between opposite edges 34. The edges 34 of the wear strip 32 are resilient so as to snap fit into place over the bulb. Alternatively, the wear strip 32 can be slid longitudinally into position on the bulb 30. The wear strip 32 has a substantial relative thickness to provide a long wear life.

The flexibility or resiliency of the bulb 30 assures that the wear strip 32 maintains a seal with the curved surface 24 of the drum 12. The flexibility of the bulb 30 also allows the wear strip 32 to move and absorb any eccentricity in the rotating drum 12.

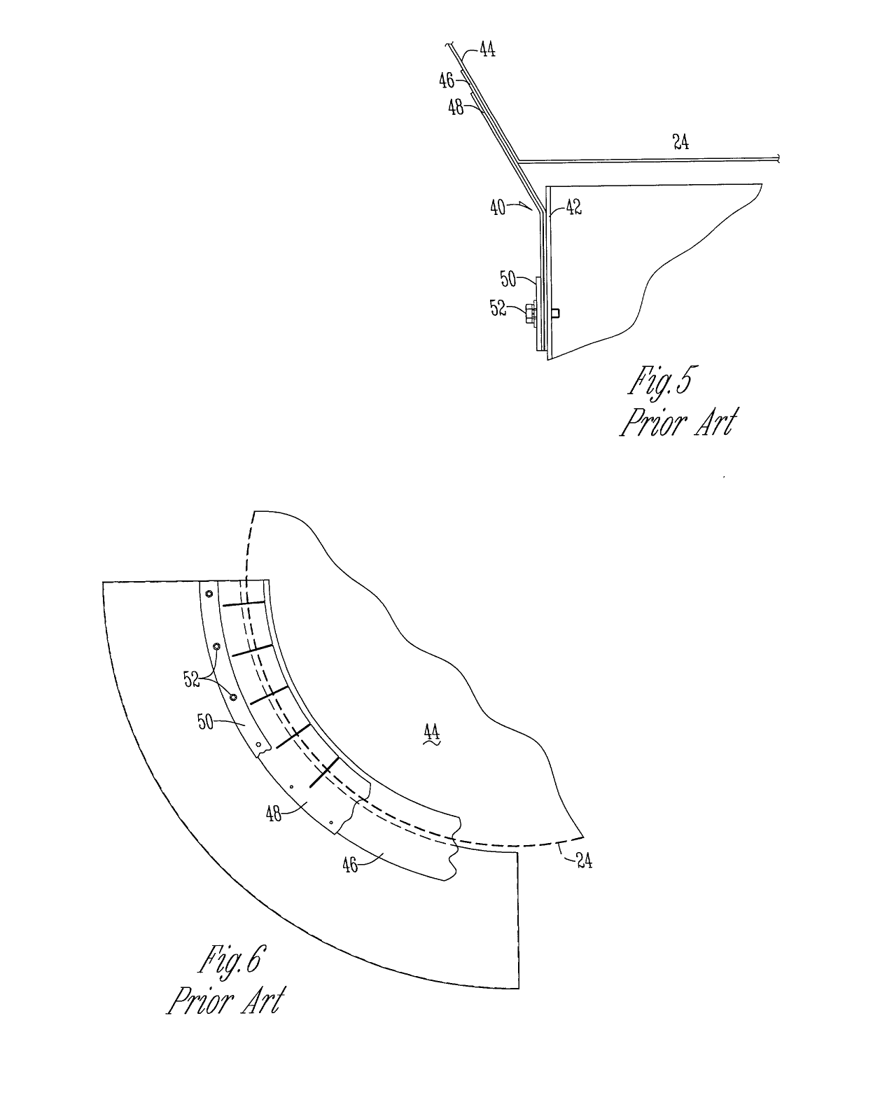

FIGS. 5 and 6 show a prior art leaf seal 40, for comparative purposes. The leaf seal 40 is mounted to the sidewall 42 of the ducts 14, 16 and extends into engagement with the sidewall 44 of the drum 12, as best seen in FIG. 5. The seal 40 includes a thin plastic leaf 46 which is retained in engagement with the sidewall 44 of the drum 12 by a plurality of metal fingers 48. A clamp band 50 is provided for strength. The assembly of the plastic leaf 46, fingers 48, and clamp band 50 is secured to the sidewall 42 of the ducts 14, 16 by bolts or rivets 52.

It is noted that the wear strip 32 of the present invention is approximately twice as thick as the plastic leaf 46 of the prior art. Accordingly, the wear strip 32 is expected to last at least twice as long as the prior art leaf strip. Also, the flexible seal 20 of the present invention can be quickly and easily changed, since no tools are required. In comparison, the leaf seal 40 of the prior art requires tools to remove and apply the rivets or bolts 52.

While the drawings show the flexible seal 20 applied to the opposite side edges 22 of the ducts 14, 16, it is understood that the seal 20 can also be used on the opposite ends 36 of the ducts 14, 16 which traverse the curved peripheral surface 24 of the drum.

Since coating drums 12 generally are not perfectly round, the seal 20 has to be able to absorb any eccentricity in the surface 24 of the drum 12. As the drum 12 rotates, the wear strip 32 is able to stay in contact with the drum surface 24 due to the flexibility of the rubber bulb 30 of the seal 20. If the wear strip 32 becomes damaged or worn through, the drum surface 24 will not be damaged, since the rubber bulb 30 is the only remaining structure contacting the drum surface.

In the drawings, machine 10 is shown to be a batch machine. It is understood that the seal 20 of the present invention can also be used on a continuous coating machine.

From the foregoing, it can be seen that the present invention accomplishes at least all of the stated objectives.

The preferred embodiment of the present invention has been set forth in the drawings, specification, and although specific terms are employed, these are used in a generic or descriptive sense only and are not used for purposes of limitation. Changes in the form and proportion of parts as well as in the substitution of equivalents are contemplated as circumstances may suggest or render expedient without departing from the spirit and scope of the invention as further defined in the following claims.

What is claimed is:

1. A seal between a rotating drum and a stationary duct, the duct having an edge spaced closely to the drum, the seal comprising:
an elongated mounting member adapted to fit over the edge of the duct;
a resilient bulb extending from the mounting member; and
a wear strip mounted over the bulb so as to be in sealing engagement with the drum.

2. The seal of claim 1 wherein the elongated member includes spaced apart legs adapted to fit on opposite sides of the edge of the duct.

3. The seal of claim 1 wherein the elongated member is friction fit onto the edge of the duct.

4. The seal of claim 1 wherein the wear strip is slip fit onto the bulb.

5. The seal of claim 1 wherein the elongated member is a vinyl extrusion.

6. The seal of claim 1 wherein the bulb is constructed of sponge rubber.

7. The seal of claim 1 wherein the bulb is constructed of neoprene.

8. The seal of claim 1 wherein the wear strip is constructed of polyethylene.

9. The seal of claim 1 wherein the wear strip is constructed of high molecular weight polyethylene.

10. An improved particulate coating machine having a perforated rotatable drum for spraying a coating solution on particulate material in the drum, an air supply for introducing drying air into the drum, and an exhaust duct for venting air from the drum, the improvement comprising:
a seal extending around a perimeter edge of the exhaust duct,
the seal including a resilient bulb with a wear strip in sealing engagement with the drum.

11. The machine of claim 10 wherein the seal further includes an elongated mounting member with a slot therein for mounting over the perimeter edge of the duct.

12. The machine of claim 11 wherein the mounting member is press fit on the perimeter edge of the duct.

13. The machine of claim 11 wherein the mounting member is an extruded piece.

14. The machine of claim 10 wherein the bulb is constructed of sponge rubber.

15. The machine of claim 10 wherein the bulb is constructed of neoprene.

16. The machine of claim 10 wherein the wear strip is constructed of polyethylene.

17. A method of sealing a rotating drum to an adjacent stationary duct, the drum having a curved surface, the method comprising:
mounting a resilient bulb seal on an edge of the duct such that a wear strip on the seal is in flexible sealing engagement with the curved surface of the drum.
